(19) United States
(12) Patent Application Publication
(10) Pub. No.: US 2025/0251748 A1
(43) Pub. Date: Aug. 7, 2025

(54) Voltage follower

(71) Applicant: REAL TEK SEMICONDUCTOR CORPORATION, Hsinchu (TW)

(72) Inventors: SHIH-HSIUNG HUANG, Hsinchu (TW); Chung-Lin Tseng, Hsinchu (TW)

(21) Appl. No.: 19/034,333

(22) Filed: Jan. 22, 2025

(30) Foreign Application Priority Data
Feb. 7, 2024 (TW) 113105072

(51) Int. Cl. G05F 1/56

(52) U.S. Cl. CPC G05F 1/56

(57) ABSTRACT

A voltage follower has a first input terminal and a first output terminal and includes a transistor, a first load, and a buffer circuit. The transistor has a gate, a source, a drain, and a body. The gate is coupled to the first input terminal, the source is coupled to the first output terminal, and the drain is coupled to a first reference voltage. The first load is coupled between the source and a second reference voltage. The buffer circuit has a second input terminal and a second output terminal. The second input terminal is coupled to the gate, and the second output terminal is coupled to the body.

### BACKGROUND OF THE INVENTION

### 1. Field of the Invention

The present invention generally relates to a voltage follower.

### 2. Description of Related Art

The conventional source follower is a type of voltage follower, and the source and body of the source follower are usually electrically connected to each other to eliminate the body effect. However, such an approach leads to a nonlinear parasitic capacitance on the body, reducing the performance of the source follower (e.g., reducing the bandwidth of the source follower), or affecting the quality of the output signal of the source follower (e.g., reducing the linearity of the output signal). Because the voltage follower is widely used in electronic circuits, there is an urgent need for a reliable voltage follower.

### SUMMARY OF THE INVENTION

In view of the issues of the prior art, an object of the present invention is to provide a voltage follower, so as to make an improvement to the prior art.

According to one aspect of the present invention, a voltage follower is provided. The voltage follower has a first input terminal and a first output terminal. The voltage follower includes a transistor, a first load, and a buffer circuit. The transistor has a gate, a source, a drain, and a body. The gate is coupled to the first input terminal. The source is coupled to the first output terminal. The drain is coupled to a first reference voltage. The first load is coupled between the source and a second reference voltage. The buffer circuit has a second input terminal and a second output terminal. The second input terminal is coupled to the gate, and the second output terminal is coupled to the body.

According to another aspect of the present invention, a voltage follower is provided. The voltage follower has a first input terminal, a second input terminal, a first output terminal, and a second output terminal. The voltage follower includes a first transistor, a first load, a first buffer circuit, a second transistor, a second load, and a second buffer circuit. The first transistor has a first gate, a first source, a first drain, and a first body. The first gate is coupled to the first input terminal, the first source is coupled to the first output terminal, and the first drain is coupled to a first reference voltage. The first load is coupled between the first source and a second reference voltage. The first buffer circuit has a third input terminal and a third output terminal. The third input terminal is coupled to the first gate, and the third output terminal is coupled to the first body. The second transistor has a second gate, a second source, a second drain, and a second body. The second gate is coupled to the second input terminal, the second source is coupled to the second output terminal, and the second drain is coupled to the first reference voltage. The second load is coupled between the second source and the second reference voltage. The second buffer circuit has a fourth input terminal and a fourth output terminal. The fourth input terminal is coupled to the second gate, and the fourth output terminal is coupled to the second body.

The technical means embodied in the embodiments of the present invention can solve at least one of the problems of the prior art. Therefore, compared to the prior art, the present invention can improve performance and signal quality.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1A is a circuit diagram of a voltage follower according to an embodiment of the present invention.

FIG. 1B is a circuit diagram of the voltage follower according to another embodiment of the present invention.

FIGS. 2A to 2C show embodiments of the buffer circuit.

FIG. 3 is a circuit diagram of the voltage follower according to another embodiment of the present invention.

FIG. 4 is a circuit diagram of the voltage follower according to another embodiment of the present invention.

FIG. 5 is a circuit diagram of the voltage follower according to another embodiment of the present invention.

FIG. 6 is a circuit diagram of the voltage follower according to another embodiment of the present invention.

FIG. 7 is a circuit diagram of the voltage follower according to another embodiment of the present invention.

FIG. 8 is a circuit diagram of the voltage follower according to another embodiment of the present invention.

FIG. 9 is a circuit diagram of the voltage follower according to another embodiment of the present invention.

FIG. 10 is a circuit diagram of the voltage follower according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a voltage follower. On account of that some or all elements of the voltage follower could be known, the detail of such elements is omitted provided that such detail has little to do with the features of this disclosure, and that this omission nowhere dissatisfies the specification and enablement requirements. A person having ordinary skill in the art can choose components or steps equivalent to those described in this specification to carry out the present invention, which means that the scope of this invention is not limited to the embodiments in the specification.

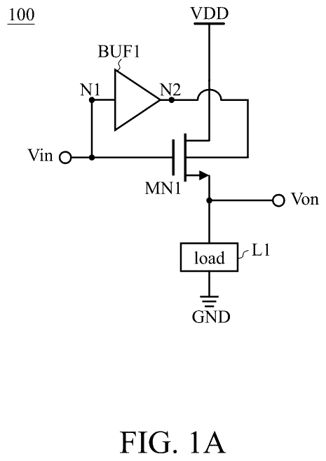

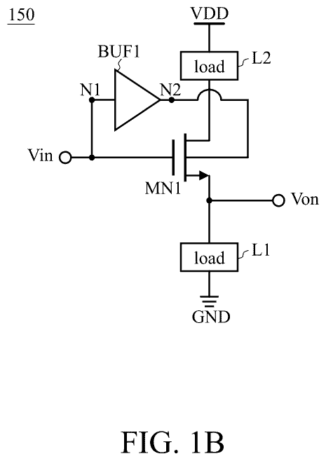

Reference is made to FIG. 1A, which is a circuit diagram of a voltage follower according to an embodiment of the present invention. A voltage follower 100 includes a transistor MN1, a load L1, and a buffer circuit BUF1.

The input terminal N1 of the buffer circuit BUF1 is coupled or electrically connected to an input terminal of the voltage follower 100 (i.e., the terminal that receives the input signal Vin); the output terminal N2 of the buffer circuit BUF1 is coupled or electrically connected to the body of the transistor MN1.

One terminal of the load L1 is coupled or electrically connected to a reference voltage GND (e.g., ground); the other terminal of the load L1 is coupled or electrically connected to the output terminal of the voltage follower 100 (i.e., the terminal that outputs the output signal Von).

The gate of the transistor MN1 is coupled or electrically connected to the input terminal of the voltage follower 100 and the input terminal N1 of the buffer circuit BUF1; the source of the transistor MN1 is coupled or electrically connected to the output terminal of the voltage follower 100 (i.e., the output signal Von is outputted from the source of the transistor MN1). The source of the transistor MN1 is not electrically connected to the body of the transistor MN1.

The relationship between the output signal Von (i.e., the source voltage of the transistor MN1) and the input signal Vin (i.e., the gate voltage of the transistor MN1) is shown in Equation (1), wherein Vgs is the gate-source voltage of the transistor MN1.

$$Von = V in - V g s \qquad ( 1 )$$

The buffer circuit BUF1 is designed to provide at its output terminal N2 a voltage that is substantially the same as the output signal Von. In this way, the source voltage of the transistor MN1 (i.e., the output signal Von) is substantially equal to the body voltage of the transistor MN1 (i.e., the voltage at the output terminal N2), thereby eliminating the body effect. For example, the gain (alternating current (AC) signal gain or small signal gain) of the buffer circuit BUF1 may be close to 1, and the common-mode voltage at the output terminal N2 differs from the common-mode voltage at the input terminal N1 by a direct current (DC) level (e.g., the DC level may be close to or substantially equal to Vgs).

Reference is made to FIG. 1B, which is a circuit diagram of the voltage follower according to another embodiment of the present invention. FIG. 1B is similar to FIG. 1A, except that the voltage follower 150 further includes a load L2. One terminal of the load L2 is coupled or electrically connected to the reference voltage VDD; the other terminal of the load L2 is coupled or electrically connected to the drain of the transistor MN1. When the voltage follower 150 is used in a negative feedback circuit (not shown), the load L2 may increase the high-frequency gain. Compared to the voltage follower 100, the voltage follower 150 is more suitable for high-speed components.

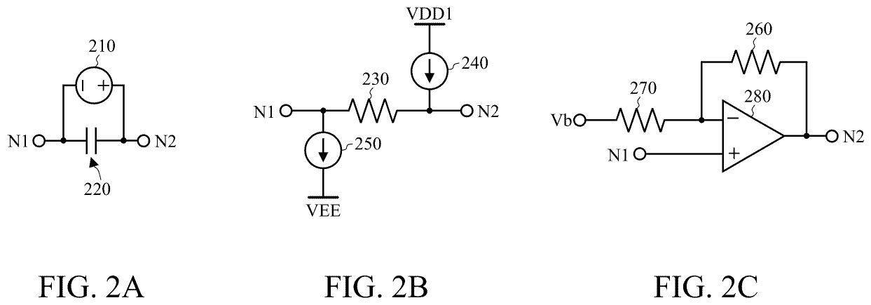

Reference is made to FIGS. 2A to 2C, which show embodiments of the buffer circuit BUF1.

As shown in FIG. 2A, the buffer circuit BUF1 includes a voltage source 210 and a capacitor 220. One terminal of the voltage source 210 is coupled or electrically connected to the input terminal N1; the other terminal of the voltage source 210 is coupled or electrically connected to the output terminal N2. One terminal of the capacitor 220 is coupled or electrically connected to the input terminal N1; the other terminal of the capacitor 220 is coupled or electrically connected to the output terminal N2.

As shown in FIG. 2B, the buffer circuit BUF1 includes a resistor 230, a current source 240, and a current source 250. One terminal of the resistor 230 is coupled or electrically connected to the input terminal N1; the other terminal of the resistor 230 is coupled or electrically connected to the output terminal N2. One terminal of the current source 240 is coupled or electrically connected to the reference voltage VDD1; the other terminal of the current source 240 is coupled or electrically connected to the output terminal N2. One terminal of the current source 250 is coupled or electrically connected to the reference voltage VEE; the other terminal of the current source 250 is coupled or electrically connected to the input terminal N1. In some embodiments, the reference voltage VDD1 may be equal to the reference voltage VDD, and the reference voltage VEE may be equal to the reference voltage GND. In other embodiments, the current source 240 and the current source 250 have an upward current direction, in which the reference voltage VDD1 may be equal to the reference voltage GND, and the reference voltage VEE may be equal to the reference voltage VDD.

As shown in FIG. 2C, the buffer circuit BUF1 includes a resistor 260, a resistor 270, and an operational amplifier (OP) 280. One terminal of the resistor 260 is coupled or electrically connected to the inverting input terminal of the OP 280; the other terminal of the resistor 260 is coupled or electrically connected to the output terminal N2. One terminal of the resistor 270 receives the reference voltage Vb; the other terminal of the resistor 270 is coupled or electrically connected to the inverting input terminal of the OP 280. The non-inverting input terminal of the OP 280 is coupled or electrically connected to the input terminal N1; the output terminal of the OP 280 is coupled or electrically connected to the output terminal N2.

People having ordinary skill in the art may make the voltage at the output terminal N2 substantially equal to the output signal Von by designing or adjusting the voltage source 210, the current source 240, the current source 250, the resistor 260, the resistor 270, and the OP 280 to eliminate the body effect.

In summary, because the body and source of the transistor MN1 are not electrically connected, the nonlinear parasitic capacitance of the body does not cause the performance of the voltage follower 100 to degrade or the signal quality of the output signal Von to deteriorate. Furthermore, because the body voltage and the source voltage of the transistor MN1 are substantially equal, the body effect does not occur in the transistor MN1.

Due to the advancement of the manufacturing process, the error in the voltage at the output terminal N2 can usually be controlled within 10 mV (only about 1.67% of the gate-source voltage Vgs, assuming Vgs=0.6 V). Therefore, the voltage at the output terminal N2 may be substantially the same as the output signal Von.

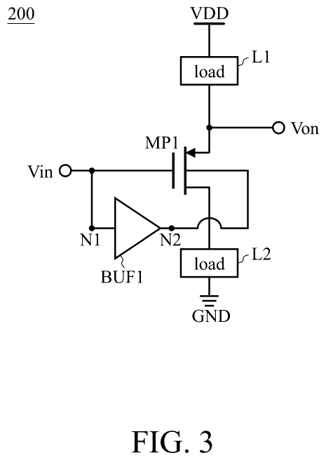

Reference is made to FIG. 3, which is a circuit diagram of the voltage follower according to another embodiment of the present invention. The voltage follower 200 includes a transistor MP1, a load L1, a load L2, and a buffer circuit BUF1. The voltage follower 200 is similar to the voltage follower 150, except that the transistor MN1 is an N-channel Metal-Oxide-Semiconductor Field-Effect Transistor (hereinafter referred to as NMOS transistor), whereas the transistor MP1 is a P-channel Metal-Oxide-Semiconductor Field-Effect Transistor (hereinafter referred to as PMOS transistor). People having ordinary skill in the art can understand the design and operating principle of the voltage follower 200 based on the discussion of the voltage follower 100, so further elaboration is omitted for brevity. Similar to the embodiments in FIG. 1A and FIG. 1B, the load L2 may be omitted.

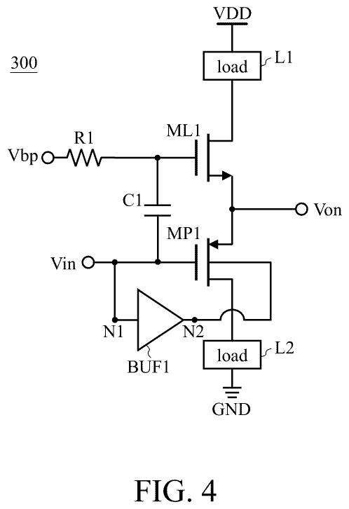

Reference is made to FIG. 4, which is a circuit diagram of the voltage follower according to another embodiment of the present invention. Compared to the voltage follower 200, the voltage follower 300 further includes a transistor ML1, a capacitor C1, and a resistor R1. The source of the transistor ML1 is coupled or electrically connected to the source of the transistor MP1 and the output terminal of the voltage follower 300; the drain of the transistor ML1 is coupled or electrically connected to the load L1. One terminal of the capacitor C1 is coupled or electrically connected to the gate of the transistor MP1; the other terminal of the capacitor C1 is coupled or electrically connected to the gate of the transistor ML1. One terminal of the resistor R1 is coupled or electrically connected to the gate of the transistor ML1; the other terminal of the resistor R1 receives the bias voltage Vbp.

The transistor ML1 is also a source follower and used to handle the high-frequency part (which is coupled to the transistor ML1 through the capacitor C1) of the input signal Vin. In other words, the transistor ML1 provides another coupling or output path for the high-frequency part of the input signal Vin. The high-frequency part of the input signal Vin is coupled to the output terminal of the voltage follower 300 through the transistor MP1 and the transistor ML1 simultaneously.

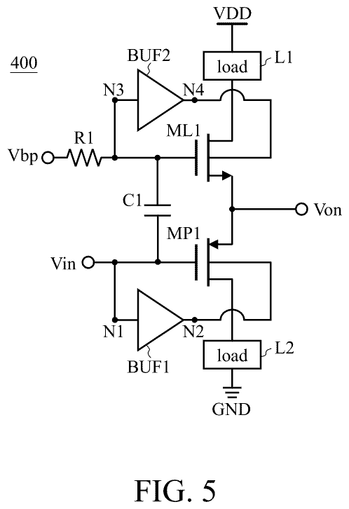

Reference is made to FIG. 5, which is a circuit diagram of the voltage follower according to another embodiment of the present invention. Compared to the voltage follower 300, the voltage follower 400 further includes a buffer circuit BUF2. The input terminal N3 of the buffer circuit BUF2 is coupled or electrically connected to the gate of the transistor ML1; the output terminal N4 of the buffer circuit BUF2 is coupled or electrically connected to the body of the transistor ML1. The function of the buffer circuit BUF2 is similar to that of the buffer circuit BUF1, where the buffer circuit BUF2 is used to bias the body of the transistor ML1 to eliminate the body effect of the transistor ML1. It should be noted that the source of the transistor ML1 is not electrically connected to the body of the transistor ML1.

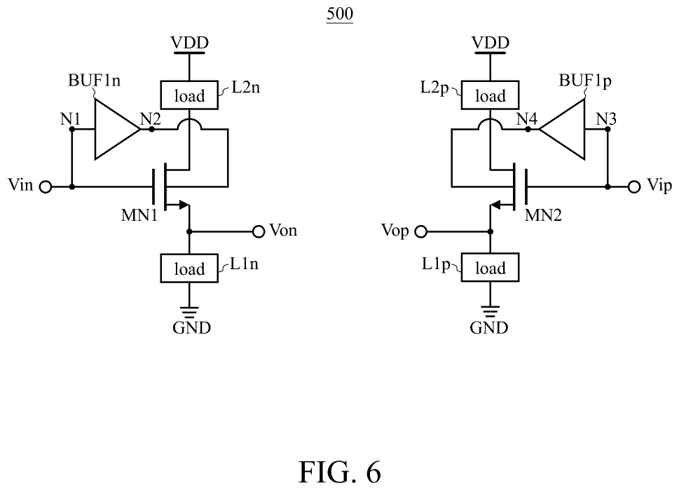

Reference is made to FIG. 6, which is a circuit diagram of the voltage follower according to another embodiment of the present invention. The voltage follower 500 includes the transistor MN1, the load Lin, the load L2n, the buffer circuit BUF1n, the transistor MN2, the load L1p, the load L2p, and the buffer circuit BUF1p.

The input terminal N1 of the buffer circuit BUF1n is coupled or electrically connected to the first input terminal of the voltage follower 500 (i.e., the terminal that receives the input signal Vin); the output terminal N2 of the buffer circuit BUF1n is coupled or electrically connected to the body of the transistor MN1.

One terminal of the load L2n is coupled or electrically connected to the reference voltage VDD; the other terminal of the load L2n is coupled or electrically connected to the drain of the transistor MN1.

One terminal of the load Lin is coupled or electrically connected to the reference voltage GND; the other terminal of the load Lin is coupled or electrically connected to a first output terminal of the voltage follower 500 (i.e., the terminal that outputs the output signal Von).

The gate of the transistor MN1 is coupled or electrically connected to the first input terminal of the voltage follower 500 and the input terminal N1 of the buffer circuit BUF1n; the source of the transistor MN1 is coupled or electrically connected to the first output terminal of the voltage follower 500. The source of the transistor MN1 is not electrically connected to the body of the transistor MN1.

The input terminal N3 of the buffer circuit BUF1p is coupled or electrically connected to the second input terminal of the voltage follower 500 (i.e., the terminal that receives the input signal Vip); the output terminal N4 of the buffer circuit BUF1p is coupled or electrically connected to the body of the transistor MN2.

One terminal of the load L2p is coupled or electrically connected to the reference voltage VDD; the other terminal of the load L2p is coupled or electrically connected to the drain of the transistor MN2.

One terminal of the load L1p is coupled or electrically connected to the reference voltage GND; the other terminal of the load L1p is coupled or electrically connected to the second output terminal of the voltage follower 500 (i.e., the terminal that outputs the output signal Vop).

The gate of the transistor MN2 is coupled or electrically connected to the second input terminal of the voltage follower 500 and the input terminal N3 of the buffer circuit BUF1p; the source of the transistor MN2 is coupled or electrically connected to the second output terminal of the voltage follower 500. The source of the transistor MN2 is not electrically connected to the body of the transistor MN2.

The input signal Vin and the input signal Vip are a differential signal pair, and the output signal Von and the output signal Vop are also a differential signal pair. In other words, the voltage follower 100 is an implementation for a single-ended signal, whereas the voltage follower 500 is an implementation for a corresponding differential signal. People having ordinary skill in the art can understand the operating principle of the voltage follower 500 based on the discussion of the voltage follower 100, so further elaboration is omitted for brevity.

Similar to the embodiments in FIG. 1A and FIG. 1B, the load L2n and the load L2p may be omitted.

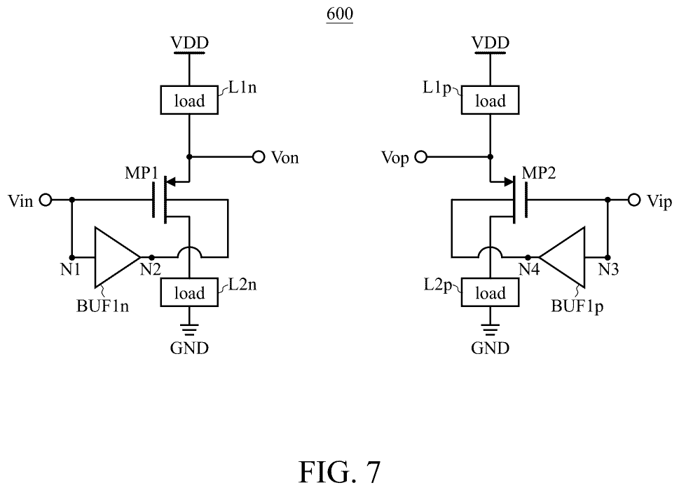

Reference is made to FIG. 7, which is a circuit diagram of the voltage follower according to another embodiment of the present invention. The voltage follower 600 includes the transistor MP1, the load Lin, the load L2n, the buffer circuit BUF1n, the transistor MP2, the load L1p, the load L2p, and the buffer circuit BUF1p. The voltage follower 600 is similar to the voltage follower 500, except that the transistor MN1 and the transistor MN2 are NMOS transistors, while the transistor MP1 and the transistor MP2 are PMOS transistors. People having ordinary skill in the art can understand the design and operating principle of the voltage follower 600 based on the discussion of the voltage follower 500, so further elaboration is omitted for brevity.

Similar to the embodiments in FIG. 1A and FIG. 1B, the load L2n and the load L2p may be omitted.

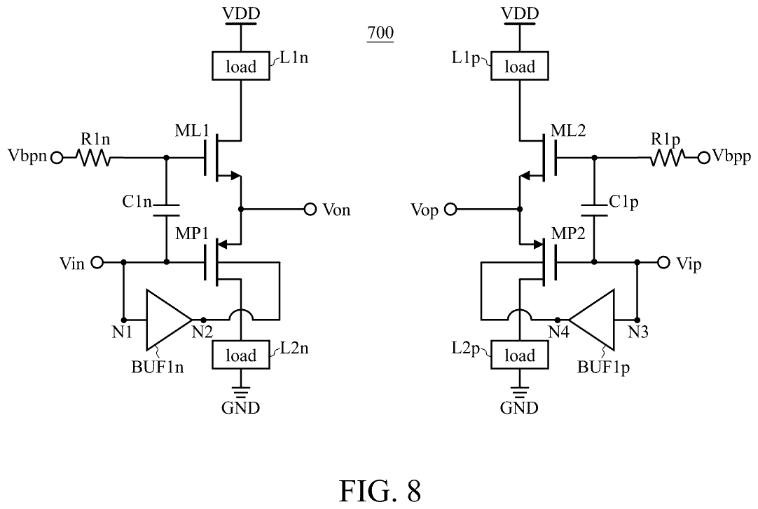

Reference is made to FIG. 8, which is a circuit diagram of the voltage follower according to another embodiment of the present invention. Compared to the voltage follower 600, the voltage follower 700 further includes the transistor ML1, the capacitor C1n, the resistor R1n, the transistor ML2, the capacitor C1p, and the resistor R1p.

The source of the transistor ML1 is coupled or electrically connected to the source of the transistor MP1 and the first output terminal of the voltage follower 700; the drain of the transistor ML1 is coupled or electrically connected to the load L1n. One terminal of the capacitor CIn is coupled or electrically connected to the gate of the transistor MP1; the other terminal of the capacitor C1n is coupled or electrically connected to the gate of the transistor ML1. One terminal of the resistor R1n is coupled or electrically connected to the gate of the transistor ML1; the other terminal of the resistor R1n receives the bias voltage Vbpn.

The source of the transistor ML2 is coupled or electrically connected to the source of the transistor MP2 and the second output terminal of the voltage follower 700; the drain of the transistor ML2 is coupled or electrically connected to the load L1p. One terminal of the capacitor C1p is coupled or electrically connected to the gate of the transistor MP2; the other terminal of the capacitor C1p is coupled or electrically connected to the gate of the transistor ML2. One terminal of the resistor R1p is coupled or electrically connected to the gate of the transistor ML2; the other terminal of the resistor R1p receives the bias voltage Vbpp.

The voltage follower 300 is an implementation for a single-ended signal, whereas the voltage follower 700 is an implementation for a corresponding differential signal. People having ordinary skill in the art can understand the operating principle of the voltage follower 700 based on the discussion of the voltage follower 300, so further elaboration is omitted for brevity.

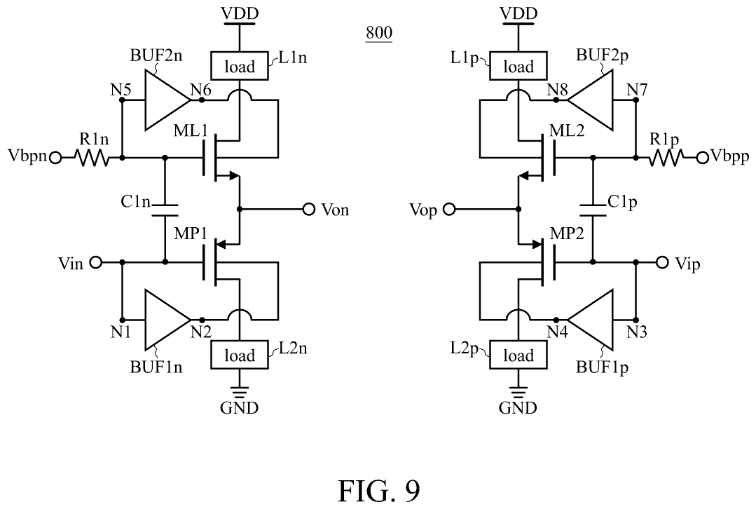

Reference is made to FIG. 9, which is a circuit diagram of the voltage follower according to another embodiment of the present invention. Compared to the voltage follower 700, the voltage follower 800 further includes a buffer circuit BUF2n and a buffer circuit BUF2p. The input terminal N5 of the buffer circuit BUF2n is coupled or electrically connected to the gate of the transistor ML1; the output terminal N6 of the buffer circuit BUF2n is coupled or electrically connected to the body of the transistor ML1. The input terminal N7 of the buffer circuit BUF2p is coupled or electrically connected to the gate of the transistor ML2; the output terminal N8 of the buffer circuit BUF2p is coupled or electrically connected to the body of the transistor ML2. The functions of the buffer circuits BUF2n and BUF2p are similar to those of the buffer circuits BUF1n and BUF1p. The buffer circuit BUF2n and the buffer circuit BUF2p are respectively used to bias the body of the transistor ML1 and the body of the transistor ML2, in order to eliminate the body effect of the transistor ML1 and the transistor ML2.

It should be noted that, in the embodiment of FIG. 9, the source of the transistor ML1 is not electrically connected to the body of the transistor ML1, and the source of the transistor ML2 is not electrically connected to the body of the transistor ML2.

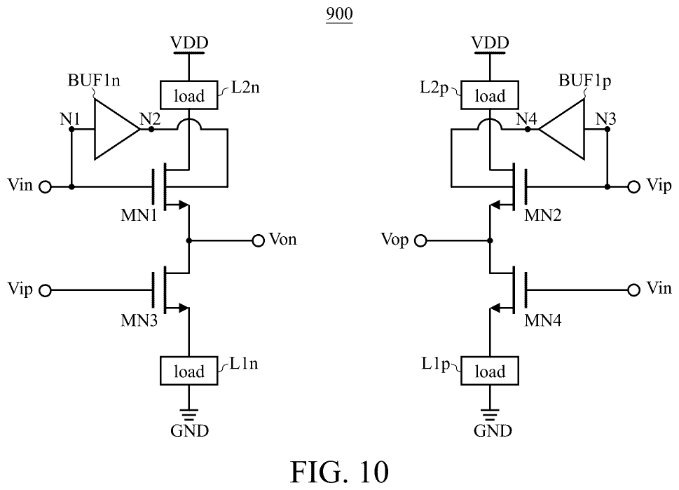

Reference is made to FIG. 10, which is a circuit diagram of the voltage follower according to another embodiment of the present invention. Compared to the voltage follower 500, the voltage follower 900 further includes a transistor MN3 and a transistor MN4. The transistor MN3 and the transistor MN4 are respectively used to provide additional gain for the output signal Von and the output signal Vop.

The gate of the transistor MN3 is coupled or electrically connected to the second input terminal of the voltage follower 900 (i.e., the terminal that receives the input signal Vip); the drain of the transistor MN3 is coupled or electrically connected to the source of the transistor MN1 and the first output terminal of the voltage follower 900 (i.e., the terminal that outputs the output signal Von); the source of the transistor MN3 is coupled or electrically connected to the load L1n.

The gate of the transistor MN4 is coupled or electrically connected to the first input terminal of the voltage follower 900 (i.e., the terminal that receives the input signal Vin); the drain of the transistor MN4 is coupled or electrically connected to the source of the transistor MN2 and the second output terminal of the voltage follower 900 (i.e., the terminal that outputs the output signal Vop); the source of the transistor MN4 is coupled or electrically connected to the load L1p.

The buffer circuits in FIGS. 1A, 1B, and 3 to 10 may all be embodied by the circuits of FIG. 2A, FIG. 2B, or FIG. 2C. Since the main function of the buffer circuits is to make the body voltage of the main transistors of the voltage follower (e.g., the transistors MN1, MP1, MN2, MP2, ML1, and ML2) close to or substantially equal to the source voltage, the buffer circuits basically do not require a driving capability, and therefore have a small area and low power consumption.

As shown in FIG. 2A to FIG. 2C, in some embodiments, the input signal and the output signal of the buffer circuits are in phase.

In some implementations, the gain of the buffer circuits is substantially 1.

In some embodiments, the loads L1, L2, LIn, L1p, L2n, and L2p may be passive components (e.g., a resistor) or active components (e.g., a current source, a diode-connected MOSFET).

In summary, in the voltage follower proposed in this disclosure, because the nonlinear parasitic capacitance connected to the body of the main transistor is not on the main signal path (i.e., the path from the gate to the source of the main transistor), the nonlinear parasitic capacitance does not affect the linearity of the signal on the main signal path, and therefore the performance of the voltage follower may be improved. Furthermore, because there is no nonlinear capacitance value, the bandwidth of the voltage follower is also increased.

Note that the shape, size, and ratio of any element in the disclosed figures are exemplary for understanding, not for limiting the scope of this invention.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A voltage follower having a first input terminal and a first output terminal, the voltage follower comprising:
a transistor having a gate, a source, a drain, and a body, wherein the gate is coupled to the first input terminal, the source is coupled to the first output terminal, and the drain is coupled to a first reference voltage;
a first load coupled between the source and a second reference voltage; and
a buffer circuit having a second input terminal and a second output terminal, wherein the second input terminal is coupled to the gate, and the second output terminal is coupled to the body.

2. The voltage follower of claim 1, wherein the source is not electrically connected to the body.

3. The voltage follower of claim 2, wherein a voltage difference between the source and the gate is substantially equal to a voltage difference between the second output terminal and the second input terminal.

4. The voltage follower of claim 2, further comprising:
a second load coupled between the drain and the first reference voltage.

5. The voltage follower of claim 4, wherein the transistor is a first transistor, the gate is a first gate, the source is a first source, the drain is a first drain, the voltage follower further comprising:
a second transistor having a second gate, a second source, and a second drain, wherein the second source is coupled to the first source, and the second drain is coupled to the first load;
a resistor, wherein one terminal of the resistor is coupled to the second gate, and another terminal of the resistor is coupled to a bias voltage; and
a capacitor, wherein one terminal of the capacitor is coupled to the first gate, and another terminal of the capacitor is coupled to the second gate.

6. The voltage follower of claim 5, wherein the body is a first body, the buffer circuit is a first buffer circuit, and the second transistor further has a second body, the voltage follower further comprising:
a second buffer circuit having a third input terminal and a third output terminal, wherein the third input terminal is coupled to the second gate, and the third output terminal is coupled to the second body.

7. The voltage follower of claim 1, wherein the buffer circuit comprises:
a voltage source, wherein one terminal of the voltage source is coupled to the second input terminal, and another terminal of the voltage source is coupled to the second output terminal; and
a capacitor, wherein one terminal of the capacitor is coupled to the second input terminal, and another terminal of the capacitor is coupled to the second output terminal.

8. The voltage follower of claim 1, wherein the buffer circuit comprises:
a resistor, wherein one terminal of the resistor is coupled to the second input terminal, and another terminal of the resistor is coupled to the second output terminal;
a first current source, wherein one terminal of the first current source is coupled to the second output terminal, and another terminal of the first current source is coupled to a third reference voltage; and
a second current source, wherein one terminal of the second current source is coupled to the second input terminal, and another terminal of the second current source is coupled to a fourth reference voltage.

9. The voltage follower of claim 1, wherein the buffer circuit comprises:
an operational amplifier having an inverting input terminal, a non-inverting input terminal, and a third output terminal, wherein the non-inverting input terminal is coupled to the second input terminal, and the third output terminal is coupled to the second output terminal;
a first resistor, wherein one terminal of the first resistor is coupled to the inverting input terminal, and another terminal of the first resistor is coupled to the second output terminal; and
a second resistor, wherein one terminal of the second resistor is coupled to a third reference voltage, and another terminal of the second resistor is coupled to the inverting input terminal.

10. The voltage follower of claim 1, wherein the first load is a resistor, a current source, or a diode-connected metal-oxide-semiconductor field-effect transistor.

11. A voltage follower having a first input terminal, a second input terminal, a first output terminal, and a second output terminal, the voltage follower comprising:
a first transistor having a first gate, a first source, a first drain, and a first body, wherein the first gate is coupled to the first input terminal, the first source is coupled to the first output terminal, and the first drain is coupled to a first reference voltage;
a first load coupled between the first source and a second reference voltage;
a first buffer circuit having a third input terminal and a third output terminal, wherein the third input terminal is coupled to the first gate, and the third output terminal is coupled to the first body;
a second transistor having a second gate, a second source, a second drain, and a second body, wherein the second gate is coupled to the second input terminal, the second source is coupled to the second output terminal, and the second drain is coupled to the first reference voltage;
a second load coupled between the second source and the second reference voltage; and
a second buffer circuit having a fourth input terminal and a fourth output terminal, wherein the fourth input terminal is coupled to the second gate, and the fourth output terminal is coupled to the second body.

12. The voltage follower of claim 11, wherein the first source is not electrically connected to the first body, and the second source is not electrically connected to the second body.

13. The voltage follower of claim 12, wherein a voltage difference between the first source and the first gate is substantially equal to a voltage difference between the third output terminal and the third input terminal, and a voltage difference between the second source and the second gate is substantially equal to a voltage difference between the fourth output terminal and the fourth input terminal.

14. The voltage follower of claim 12, further comprising:
a third load coupled between the first drain and the first reference voltage; and
a fourth load coupled between the second drain and the first reference voltage.

15. The voltage follower of claim 14, further comprising:
a third transistor having a third gate, a third source, and a third drain, wherein the third source is coupled to the first source, and the third drain is coupled to the first load;
a first resistor, wherein one terminal of the first resistor is coupled to the third gate, and another terminal of the first resistor is coupled to a first bias voltage;
a first capacitor, wherein one terminal of the first capacitor is coupled to the first gate, and another terminal of the first capacitor is coupled to the third gate;
a fourth transistor having a fourth gate, a fourth source, and a fourth drain, wherein the fourth source is coupled to the second source, and the fourth drain is coupled to the second load;
a second resistor, wherein one terminal of the second resistor is coupled to the fourth gate, and another terminal of the second resistor is coupled to a second bias voltage; and
a second capacitor, wherein one terminal of the second capacitor is coupled to the second gate, and another terminal of the second capacitor is coupled to the fourth gate.

16. The voltage follower of claim 15, wherein the third transistor further has a third body, and the fourth transistor further has a fourth body, the voltage follower further comprising:
a third buffer circuit having a fifth input terminal and a fifth output terminal, wherein the fifth input terminal is coupled to the third gate, and the fifth output terminal is coupled to the third body; and
a fourth buffer circuit having a sixth input terminal and a sixth output terminal, wherein the sixth input terminal is coupled to the fourth gate, and the sixth output terminal is coupled to the fourth body.

17. The voltage follower of claim 14, wherein the voltage follower further comprises:
a third transistor having a third gate, a third source, and a third drain, wherein the third source is coupled to the first load, the third drain is coupled to the first output terminal, and the third gate is coupled to the second input terminal; and
a fourth transistor having a fourth gate, a fourth source, and a fourth drain, wherein the fourth source is coupled to the second load, the fourth drain is coupled to the second output terminal, and the fourth gate is coupled to the first input terminal.

18. The voltage follower of claim 11, wherein the first buffer circuit or the second buffer circuit comprises:
a voltage source, wherein one terminal of the voltage source is coupled to the second input terminal, and another terminal of the voltage source is coupled to the second output terminal; and
a capacitor, wherein one terminal of the capacitor is coupled to the second input terminal, and another terminal of the capacitor is coupled to the second output terminal.

19. The voltage follower of claim 11, wherein the first buffer circuit or the second buffer circuit comprises:
a resistor, wherein one terminal of the resistor is coupled to the second input terminal, and another terminal of the resistor is coupled to the second output terminal;
a first current source, wherein one terminal of the first current source is coupled to the second output terminal, and another terminal of the first current source is coupled to a third reference voltage; and
a second current source, wherein one terminal of the second current source is coupled to the second input terminal, and another terminal of the second current source is coupled to a fourth reference voltage.

20. The voltage follower of claim 11, wherein the first buffer circuit or the second buffer circuit comprises:
an operational amplifier having an inverting input terminal, a non-inverting input terminal, and a fifth output terminal, wherein the non-inverting input terminal is coupled to the second input terminal, and the fifth output terminal is coupled to the second output terminal;
a first resistor, wherein one terminal of the first resistor is coupled to the inverting input terminal, and another terminal of the first resistor is coupled to the second output terminal; and
a second resistor, wherein one terminal of the second resistor is coupled to a third reference voltage, and another terminal of the second resistor is coupled to the inverting input terminal.
